(19) United States
(12) Patent Application Publication
(10) Pub. No.: US 2020/0321727 A1
(43) Pub. Date: Oct. 8, 2020

(54) STRAP UNLOCKING MECHANISM AND CONNECTOR

(71) Applicant: Dongguan Luxshare Technologies Co., Ltd, Dongguan City (CN)

(72) Inventors: TieSheng LI, Dongguan City (CN); Long JIN, Dongguan City (CN); ZhaoLong ZENG, Dongguan City (CN); QiongNan CHEN, Dongguan City (CN)

(73) Assignee: Dongguan Luxshare Technologies Co., Ltd, Dongguan City (CN)

(21) Appl. No.: 16/837,620

(22) Filed: Apr. 1, 2020

(30) Foreign Application Priority Data
Apr. 2, 2019 (CN) 201910259652.X

(51) Int. Cl. H01R 13/627; H01R 13/633

(52) U.S. Cl. CPC H01R 13/6275; H01R 13/6335

(57) ABSTRACT

The present disclosure provides a strap unlocking mechanism adapted for a cable plug and a connector. The strap unlocking mechanism comprises an elastic latch, a strap and an abutting rod. The elastic latch comprises a locking portion and an unlocking elastic piece disposed on the cable plug. The unlocking elastic piece is connected to one side of the locking portion. One end of the strap is connected with the unlocking elastic piece. The abutting rod is disposed on the cable plug and abuts against a surface of the strap close to the unlocking elastic piece. A first pull end and a second pull end are defined on the strap by the abutting rod. The extension direction of the first pull end and the extension direction of the second pull end being different.

### CROSS REFERENCE TO RELATED APPLICATION

This application claims the priority benefit of Chinese Patent Application Serial Number 201910259652.X, filed on Apr. 2, 2019, the full disclosure of which is incorporated herein by reference.

### BACKGROUND

### Technical Field

This present disclosure generally relates to a strap unlocking mechanism and a connector having the strap unlocking mechanism.

### Related Art

At present, the connector with the locking structure mostly releases the lock by hand pressing. Sufficient space must be reserved for fingers to press when designing the lock structure, which is not conducive to the development and disclosure of miniaturization and thinning of the product. Therefore, the prior art proposed an improved manner, which is a strap unlocking mechanism, to solve the problems. However, the fixing manner for the strap structure is one disadvantages of the existing strap. One end of the strap is usually fixed to the unlocking structure. Structures must be able to match each other to be able to be combined for use and thus the connection relationship is fixed. Therefore, the unlocking structure and the latching structure generally have less tolerance in manufacturing and assembly. Further, because of structural limitations, the mobility of the lock structure in use is limited, and the ease of use is also affected.

### SUMMARY

The technical problem to be solved by the embodiments of the present discourse cannot be solved by the solutions of the prior art. In the prior art, a connector with a locking structure is currently used for the unlocking structure to be directly fixed to the locking structure. This limits the activity of the connection structure of the unlocking structure and the latch structure. There are many inconveniences in use. In view of this, the present disclosure discloses a strap unlocking mechanism and a connector to solve the above problems of the prior art.

The present disclosure provides the following embodiments.

In one embodiment, the present disclosure provides a strap unlocking mechanism adapted for a cable plug. The strap unlocking mechanism comprises an elastic latch, a strap and an abutting rod. The elastic latch comprises a locking portion and an unlocking elastic piece disposed on the cable plug. The unlocking elastic piece is connected to one side of the locking portion. One end of the strap is connected with the unlocking elastic piece. The abutting rod is disposed on the cable plug and against a surface of the strap close to the unlocking elastic piece. A first pull end and a second pull end are defined on the strap by the abutting rod. The extension direction of the first pull end and the extension direction of the second pull end being different.

In one embodiment, the present disclosure provides a connector. The connector comprises a cable plug having a top with a slot, a strap unlocking mechanism according to the above embodiment, and a board plug. The unlocking portion is disposed in the slot; two ends of the abutting rod being disposed on two opposite side walls of the slot. The board plug comprises a fixing portion connected to the locking portion; the board plug is disposed on the cable plug.

The problems or disadvantages of the prior art are improved by the strap unlocking mechanism and connector disclosed herein. The elastic latch of the present disclosure may be released by the strap through the structure design of the strap and the abutting rod. The design of the abutting rod may change the direction of the force applied to the elastic latch. In one hand, the abutting rod changes the direction of the force applied to the elastic latch. This direction of this force is the most labor-saving and the easiest to unlock the elastic latch by deformation. On the other hand, as long as the user pulls the strap away from the cable plug, the direction of the force that the strap acts on the elastic latch is limited by the abutting rod, and then is changed as the direction of the force for unlocking. Thus, there is more activity for the direction for the force by the strap pulled by the user. One side of the strap is fixed at the elastic latch. The middle part of the strap abuts against the abutting rod. Thus, the path through which the strap is pulled is fixed. This path is the direction of the force that the strap applies to the elastic latch. Therefore, the direction of the force applied to the first half of the strap at the abutting rod is fixed. The pulling direction of the rear half of the strap at the abutting rod has little influence on the direction of application of the first half of the strap. Therefore, it is more flexible to pull the strap to unlock.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is a schematic view of a connector of a first embodiment of the present disclosure;

FIG. 2 is an exploded perspective view of the connector of the first embodiment of the present disclosure;

FIG. 3 is another exploded perspective view of the connector of the first embodiment of the present disclosure;

FIG. 4 is a cross-sectional view of the connector of the first embodiment of the present disclosure;

FIG. 5 is a cross-sectional view showing the operation of the connector of the first embodiment of the present disclosure;

FIG. 6 is another cross-sectional view showing the operation of the connector of the first embodiment of the present disclosure;

FIG. 7 is a schematic view of a strap unlocking mechanism and a cable plug of a second embodiment of the present disclosure; and

FIG. 8 is a cross-sectional of a strap unlocking mechanism and a cable plug of a second embodiment of the present disclosure.

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

In the following embodiment, the same reference numerals is used to refer to the same or similar elements throughout the disclosure.

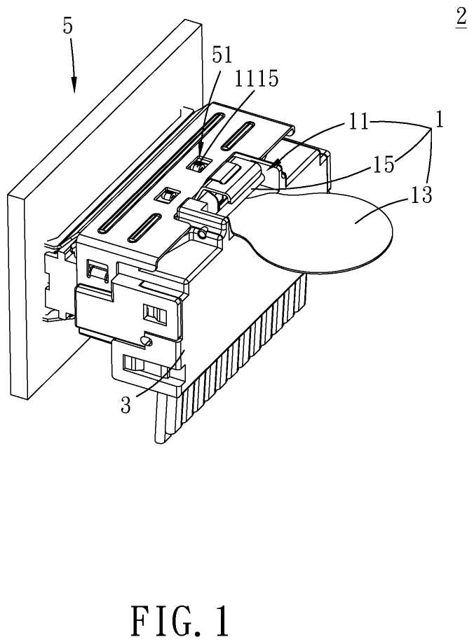

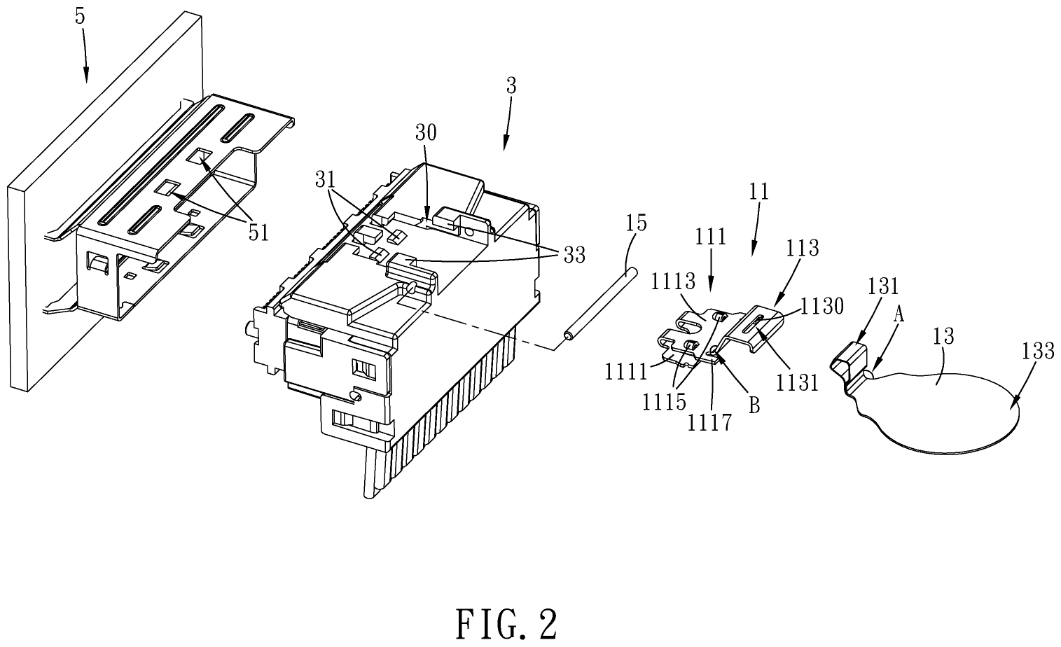

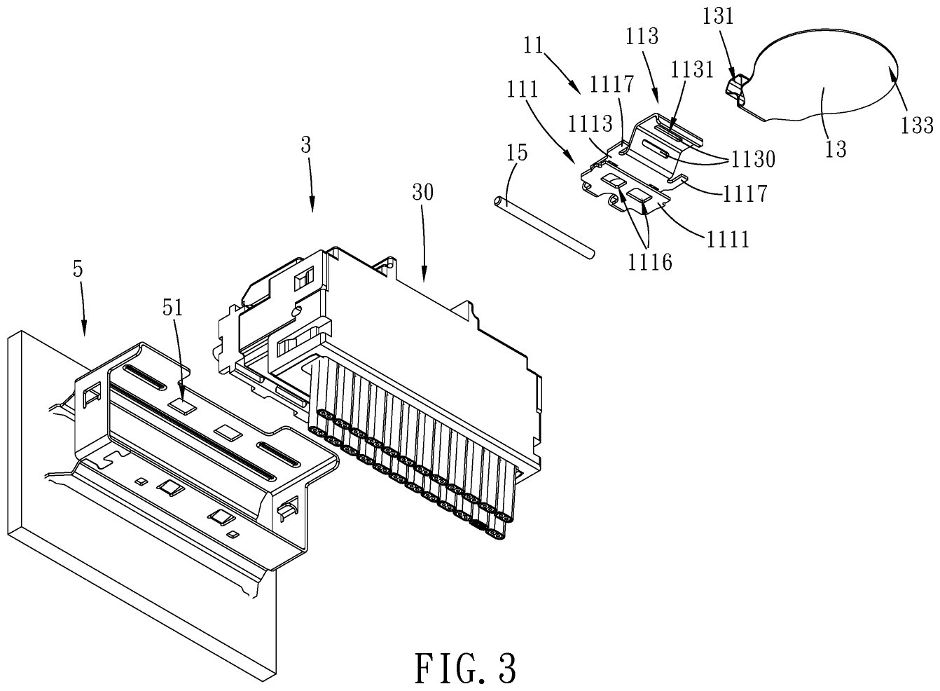

FIG. 1 is a schematic view of a connector of a first embodiment of the present disclosure. FIG. 2 is an exploded perspective view of the connector of the first embodiment of the present disclosure. FIG. 3 is another exploded perspective view of the connector of the first embodiment of the present disclosure. As shown in the figure, the present embodiment provides a strap unlocking mechanism 1 adapted to the cable plug 3. The connector 2 includes the strap unlocking mechanism 1, the cable plug 3 and a board plug 5. The connector 2 can lock (or unlock) the cable plug 3 to (from) the board plug 5 by the strap unlocking mechanism 1. The strap unlocking mechanism 1 of the present embodiment includes an elastic latch 11, a strap 13 and an abutting rod 15.

In accordance with the above description, the elastic latch 11 includes a locking portion 111 and an unlocking elastic piece 113 disposed on the cable plug 3. The unlocking elastic piece 113 is connected to one side of the locking portion 111. One side of the strap 13 is connected to the unlocking elastic piece 113. The abutting rod 15 is disposed on the cable plug 3 and abuts against the surface of the strap 13 close to the unlocking elastic piece 113. A first pull end 131 and a second pull end 133 may be defined on the strap 13 by the abutting rod 15. The extension direction of the first pull end 131 and the extension direction of the second pull end 133 are different. The extension direction of the first pull end 131 to the abutting rod 15 and the extension direction of the abutting rod 15 to the second pull end 133 respectively represent two directions of forces. The direction of force of the first pull end 131 to the abutting rod 15 is the direction of force that the strap 13 directly acts on the elastic latch 11. This direction is for deformation of the elastic latch 11 for unlocking. The extension direction of the abutting rod 15 to the second pull end 133 is the direction of force that the user pulls the strap 13. When the user pulls the strap 13 away from the cable plug 3 horizontally, obliquely or obliquely downward, the extension direction of the abutting rod 15 to the second pull end 133 would change with the pull direction.

In this embodiment, the locking portion 111 further includes a connecting piece 1111 and a locking elastic piece 1113. One side of the connecting piece 1111 is connected to one side of the locking elastic piece 1113. A U-shaped bend of 180 degrees is formed at the junction of the connecting side of the locking elastic piece 1113 and the connecting side of the connecting piece 1111. Through the U-shaped junction, the locking elastic piece 1113 are disposed above the connecting piece 1111. The structure of the locking elastic piece 1113 and the connecting piece 1111 is elastic. The other side of the locking elastic piece 1113 is connected to the unlocking elastic piece 113. An angel (i.e., the second angle B) is formed at the junction between the locking elastic piece 1113 and the unlocking elastic piece 113. This angel is an obtuse angle greater than ninety degrees. In other words, the locking portion 111 and the unlocking elastic piece 113 have an obtuse angle greater than ninety degrees.

The top of the cable plug 3 has a slot 30. The locking portion 111 of the elastic latch 11 is disposed in the slot 30. The connecting piece 1111 of the locking portion 111 has positioning holes 1116. The cable plug 3 has positioning bumps 31 corresponding to the positioning holes 1116. The displacement of the elastic latch 11 on the cable plug 3 in the horizontal direction is thus limited. Limiting protrusions 1117 are formed at one side of the locking elastic piece 1113 connected to the unlocking elastic piece 113. The cable plug 3 has limiting columns 33 corresponding to the limiting protrusions 1117. When the elastic latch 11 is disposed on the cable plug 3, the limiting protrusions 1117 abut against the limiting columns 33 of the cable plug 3. The displacement of the elastic lock 11 on the cable plug 3 in the vertical direction is thus limited. In this embodiment, the elastic latch 11 is fixed to the cable plug 3 in the above manner.

The abutting rod 15 is disposed on the cable plug 3. The two ends of the abutting rod 15 are disposed on the two opposite side walls of the slot 30. The abutting rod 15 is rotatably connected with the cable plug 3. The strap 13 is disposed with the unlocking elastic piece 113 of the elastic latch 11. A fixing structure 1131 is formed at the side of the unlocking elastic piece 113 away from the locking elastic piece 1113. The first pull end 131 of the strap is fixed on the fixing structure 1131 of the unlocking elastic piece 113. The second pull end 133 of the strap 13 passes through the space between the abutting rod 15 and the slot 30, and passes out in a direction away from the cable plug 3. An angle (i.e., the first angel) is formed between the first pull end 131 and the second pull end 133. The angle is greater than or equal to 90 degrees. In this embodiment, the fixing structure 1131 is formed as two openings 1130. One side of the strap 13 passes through one opening 1130 first, and then passes through the other opening 1130 to be fixed at one side of the strap 13 to form the first pull end 131. Thus, the first pull end 131 of the strap is fixed on the fixing structure 1131.

In this embodiment, the cable plug 3 is further disposed on the board plug 5 to constitute a connector 2. The board plug 5 has a fixing portion 51. The locking portion 111 of the elastic latch 11 is fixed to the fixing portion 51 of the board plug 5. Locking bumps 1115 are disposed on the surface of the locking elastic piece 1113 of the locking portion 111 away from the connecting piece 1111. The fixing portion 51 is formed as two openings. The locking bumps 1115 of the locking elastic piece 1113 are disposed in the openings. Thus, the cable plug 3 is fixed at the board plug 5.

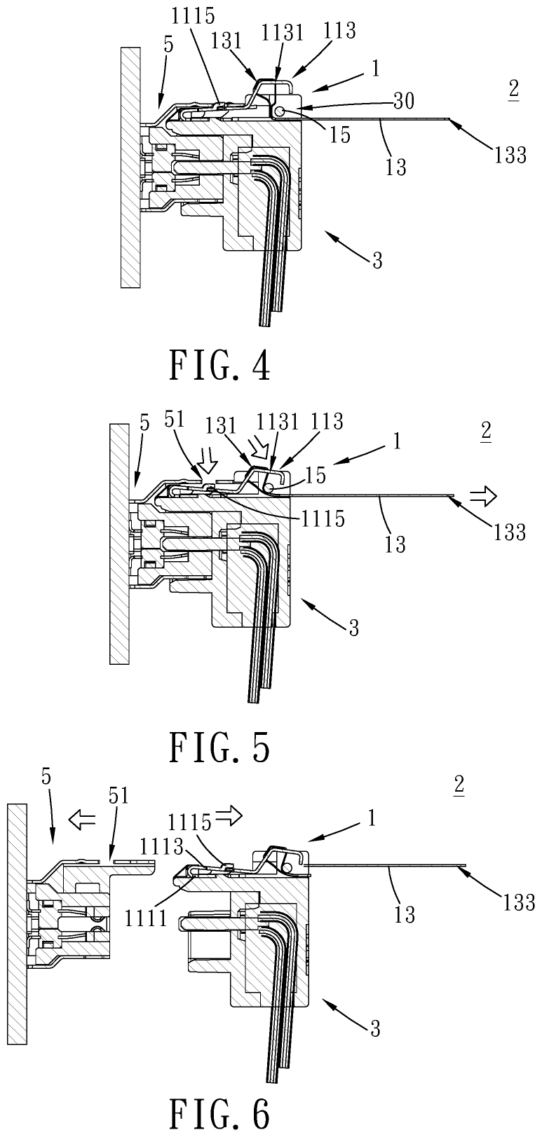

Refer to FIG. 4 to FIG. 6. FIG. 4 is a cross-sectional view of the connector of the first embodiment of the present disclosure. FIG. 5 is a cross-sectional view showing the operation of the connector of the first embodiment of the present disclosure. FIG. 6 is another cross-sectional view showing the operation of the connector of the first embodiment of the present disclosure. As shown in the figure, in the embodiment, the connector 2 is released as the following operation. The second pull end 133 of the strap 13 is pulled away from the cable plug 3. The first pull end 131 is fixed at the fixing structure 1131 of the unlicking elastic piece 113. Because the height of the fixing structure 1131 at the horizontal level is higher than the height of the abutting rod 15 at the horizontal level, the side of the strap 13 close to the abutting rod 15 moves against the abutting rod 15. Further, the position of the abutting rod 15 is fixed in the slot 30 of the cable plug 3. Therefore, when the second pull end 133 of the strap 13 is pulled to move away from the cable plug 3, the side of the strap 13 would abut against the abutting rod 15 such that the direction of the pull force is changed. The pull force moves from the fixing structure 1131 to the abutting rod 15 such that the first pull end 131 of the strap 13 is pulled downward to release to the unlocking elastic piece 113.

The unlocking elastic piece 113 pulls the locking elastic piece 1113 downward. When the locking elastic piece 1113 is pulled downward, the locking bumps 1115 of the locking elastic piece 1113 are released from the fixing portion 51 (i.e., the openings) of the board plug 5 (as shown in FIG. 5). At this time, the cable plug 3 and the strap unlocking mechanism 1 are not limited by the limiting portion 51 of the board plug 5. Thus the cable plug 3 and the strap unlocking mechanism 1 are released away from the board plug 5 (as shown in FIG. 6).

On the contrary, if the released cable plug 3 and the strap unlocking mechanism 1 are to be assembled to the board plug 5, the cable plug 3 and the strap unlocking mechanism 1 are placed corresponding to the position of the board plug 5, and then are pushed into the board plug 5. The cable plug 3 is fitted into the board plug 5. A lead structure is formed at the side of the locking bumps 1115 of the strap unlocking mechanism 1 facing the board plug 5. If the force pushing the cable plug 3 and the strap unlocking mechanism 1 is sufficiently large, the board plug 5 would push the locking elastic piece 1113 along the lead structure to further push the locking elastic piece 1113 downward. Thus, the cable plug 3 and the strap unlocking mechanism 1 are pushed into the board plug 5 for assembling. When the locking bumps 1115 of the locking elastic piece 1113 are placed in the fixing portion 51 of the board plug 5, the locking bumps 1115 of the locking elastic piece 1113 are not limited such that the locking elastic piece 1113 would resume the pressing state, thereby inserting the locking bumps 1115 into the fixing portion 51. By way of such manner the strap unlocking mechanism 1, the cable plug 3 and the board plug 5 constitute the connector 2.

The embodiments improve the shortcomings of the prior art. In the prior art, for the fixing manner of the strap, one side of the strap is limited on the unlocking mechanism. Such connection is fixed. Due to structural constraints, the activity of the locking structure is limited in use. Therefore, the embodiments provide the strap unlocking mechanism 1 and the connector 2. The connector 2 is composed of the strap unlocking mechanism 1, the cable plug 3 and the board plug 5. The unlocking manner is achieved by the design of the strap 13 of the strap unlocking mechanism 1 and the abutting rod 15. The direction of the force applied by the strap 13 may be changed by the abutting rod 15. The user may pull the strap 13 to further push the locking bumps 1115 of the elastic latch 11 to release from the fixing portion 51 of the board plug 5. Thus, the cable plug 3 and the strap unlocking mechanism 1 would not be limited by the fixing portion 51 of the board plug 5 such that the cable plug 3 and the strap unlocking mechanism 1 may be released away from the board plug 5. The direction of the force for changing the deformation of the elastic latch 11 is the direction of the force of the first strap end 131 to the abutting rod 15. This direction is limited by the direction of the force of the elastic latch 11 and the abutting rod 15 (the arrow in FIG. 5 indicates the direction of the fixed force from top to bottom). Therefore, the user pulls the strap away from the cable plug 3 to make the elastic latch 11 deform. In other words, as long as the force of the extension of the abutting rod 15 to the second strap end 133 is applied away from the cable plug 3, the force can be effectively applied to the elastic latch 11 to make the elastic latch 11 deform. Therefore, Therefore, the user has the flexibility to pull the strap 13 for unlocking. On the contrary, it is only necessary to push the cable plug 3 and the strap unlocking mechanism 1 into the board plug 5 with sufficient external force for assembly. The above structure can be used for locking and unlocking.

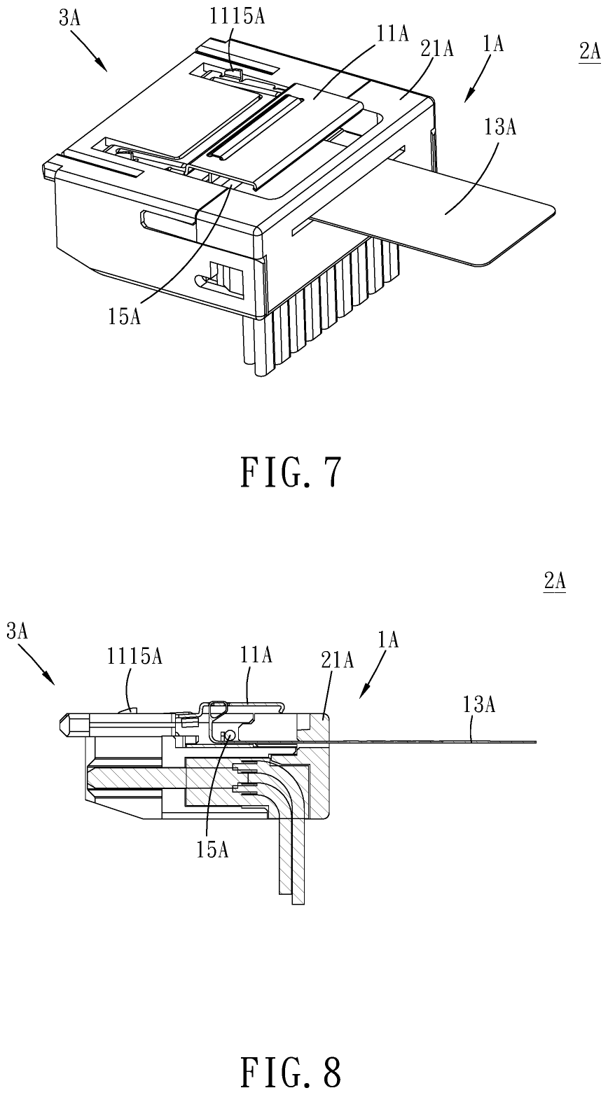

Refer to FIG. 7 and FIG. 8. FIG. 7 is a schematic view of a strap unlocking mechanism and a cable plug of a second embodiment of the present disclosure. FIG. 8 is a cross-sectional of a strap unlocking mechanism and a cable plug of a second embodiment of the present disclosure. As shown in the figure, the difference between the present embodiment and the first embodiment is that the structural style of the cable plug is not the same. This embodiment provides a combination of the strap unlocking mechanism 1A and the cable plug 3A. The strap unlocking mechanism 1A includes an elastic latch 11A, a strap 13A and an abutting rod 15A. The elastic latch 11A includes locking bumps 1115A, which may be fixed in the corresponding board plug (no shown) such that the strap unlocking mechanism 1A and the cable plug 3A. may be assembled to or released from the corresponding board plug. The operation (i.e., the locking and the unlocking) of the present embodiment is the same as that of the first embodiment, and therefore the details will not be described again. Further, the connector 2A of this embodiment includes a back cover 21A. The back cover 21A is disposed on the side of the cable plug 3A that has the strap 13A. The cable plug 13A passed through the back cover 21A.

In summary, the present embodiment provides a strap unlocking mechanism. The unlocking manner is achieved by the design of the elastic latch, the strap and the abutting rod. The interaction of the strap and the abutting rod may change the direction of the force to pull the elastic latch. As long as the user pulls the strap away from cable plug, an effective force can be applied on the elastic latch to deform the elastic latch to be released from the fixing portion of the board plug. By way of such manner, the cable plug and the strap unlocking mechanism would not be limited by the fixing portion of the board plug such that the cable plug and the strap unlocking mechanism may be released from the board plug. On the contrary, it is only necessary to push the cable plug and the strap unlocking mechanism into the board plug with sufficient external force such that the elastic latch is assembled with the fixing portion of the board plug. The above structure can be used for locking and unlocking.

It is to be understood that the term “comprises”, “comprising”, or any other variants thereof, is intended to encompass a non-exclusive inclusion, such that a process, method, article, or device of a series of elements not only includes those elements but also includes other elements that are not explicitly listed, or elements that are inherent to such a process, method, article, or device. An element defined by the phrase “comprising a . . . ” does not exclude the presence of the same element in the process, method, article, or device that comprises the element.

Although the present disclosure has been explained in relation to its preferred embodiment, it does not intend to limit the present disclosure. It will be apparent to those skilled in the art having regard to this present disclosure that other modifications of the exemplary embodiments beyond those embodiments specifically described here may be made without departing from the spirit of the disclosure. Accordingly, such modifications are considered within the scope of the disclosure as limited solely by the appended claims.

1. A strap unlocking mechanism, adapted for a cable plug, comprising:
an elastic latch comprising a locking portion and an unlocking elastic piece disposed on the cable plug, the unlocking elastic piece being connected to one side of the locking portion;
a strap, one side of which being connected with the unlocking elastic piece; and
an abutting rod, disposed on the cable plug, abutting against a surface of the strap close to the unlocking elastic piece; a first pull end and a second pull end being defined on the strap by the abutting rod; the extension direction of the first pull end and the extension direction of the second pull end being different.

2. The strap unlocking mechanism according to claim 1, wherein a first angle is formed between the first pull end and the second pull end; the angle of the first angle is greater than or equal to 90 degrees.

3. The strap unlocking mechanism according to claim 1, wherein two ends of the abutting rod are fixed to the cable plug.

4. The strap unlocking mechanism according to claim 1, wherein the abutting rod is rotatably connected with the cable plug.

5. The strap unlocking mechanism according to claim 1, wherein a second angel is formed between the unlocking elastic piece and the locking portion.

6. The strap unlocking mechanism according to claim 5, wherein the second angle is an obtuse angle.

7. The strap unlocking mechanism according to claim 1, wherein the locking portion comprises a connecting piece and a locking elastic piece; the connecting piece and the locking elastic piece are stacked sequentially; one end of the locking elastic piece is connected to one end of the connecting piece; the other end of the locking elastic piece is connected to the unlocking elastic piece.

8. The strap unlocking mechanism according to claim 7, wherein a surface of the locking elastic piece away from the connecting piece comprises locking bumps.

9. The strap unlocking mechanism according to claim 7, wherein the connecting piece comprises positioning holes; positioning bumps of the cable plug are disposed in the the positioning holes when the connecting piece is disposed on the cable plug.

10. The strap unlocking mechanism according to claim 7, wherein limiting protrusions are formed on one side of the locking elastic piece connected with the unlocking elastic piece; the limiting protrusions abut against limiting columns of the cable plug when the locking portion is disposed on the cable plug.

11. A connector, comprising:
a cable plug, having a top with a slot;
a strap unlocking mechanism according to claim 1; the unlocking portion being disposed in the slot; two ends of the abutting rod being disposed on two opposite side walls of the slot; and
a board plug, having a fixing portion connected to the locking portion; the board plug being disposed on the cable plug.

12. The connector according to claim 11, further comprises a back cover disposed at the side of the cable plug having the strap; the strap passes through the back cover.
